(19) United States
(12) Patent Application Publication
(10) Pub. No.: US 2009/0182680 A1
(43) Pub. Date: Jul. 16, 2009

(54) SYSTEM AND METHOD FOR ANONYMIZED DISCLOSURE OF CORPORATE DATA IN ELECTRONIC NEGOTIATIONS

(75) Inventors: Mark A. Heitner, Burlingame, CA (US); Jayesh Govindarajan, Sunnyvale, CA (US)

Correspondence Address: DAVIS WRIGHT TREMAINE, LLP/Seattle, 1201 Third Avenue, Suite 2200, SEATTLE, WA, 98101-3045, US

(73) Assignee: Transitiondynamics International, Inc., Burlingame, CA (US)

(21) Appl. No.: 12/413,255

(22) Filed: Mar. 27, 2009

Related U.S. Application Data
(62) Division of application No. 11/217,150, filed on Aug. 31, 2005, now abandoned.

(51) Int. Cl. G06Q 30/00; G06F 17/30

(52) U.S. Cl. 705/80; 705/26; 707/3; 707/E17.044

(57) ABSTRACT

An automated electronic negotiation system permits anonymous negotiations between one or more buyer entities and one or more seller entities. Each buyer entity and seller entity registers and provides information related to the respective entity. The information is stored confidentially and released in a step-wise fashion only upon authorization. The buyer and seller are represented by respective agents. The agents are typically software modules that conduct negotiations in accordance with a predetermined set of rules. The respective agents disclose information in response to requests during the negotiation process. Disclosures may be preauthorized or require explicit authorization of the information owner. Buyer and seller entities are assigned pseudo identities for initial negotiations. Disclosure of the true identity of the party must be explicitly authorized during the negotiation process. The system is applicable to purchases and sales of assets, mergers and acquisitions, joint ventures, partial sale of assets, and the like.

### CROSS REFERENCE TO RELATED APPLICATION

This application claims priority benefit of U.S. patent application Ser. No. 11/217,150 filed Aug. 31, 2005.

### BACKGROUND OF THE INVENTION

1. Field of the Invention

The present invention is directed generally to electronic negotiations and, more particularly, to a system and method for anonymous disclosure of corporate data in electronic negotiations.

2. Description of the Related Art

Negotiations are interactions among multiple parties, conducted for mutual gain. Parties negotiate if they have assets to exchange. The transaction may be a sale of a company, a partial sale of corporate assets, fundraising, joint developments, mergers, and the like.

The conventional approach to such transactions involves face-to-face negotiations or negotiations through an intermediary. Manual auctions and bidding systems have evolved as a means to settle on the price of goods or commodities to be exchanged.

Unfortunately, these conventional approaches make it difficult to match buyers and sellers. For example, a buyer may not be aware of all the potential sellers in the marketplace. This is particularly true if a seller is not in the same geographic location as the buyer. A buyer in California may not be aware of the existence of sellers in the Midwest. Similarly, sellers are limited in locating potential buyers.

Another difficulty in face-to-face negotiations is that the identity of the buyer and seller are revealed to both parties. This often affects the outcome of negotiations. For example, if the seller is aware that the buyer is a large well-known corporation, the selling price may be affected. Therefore, it can be appreciated that there is a significant need for a system and method for anonymous step-wise disclosure of corporate data in business negotiations. The present invention provides this and other advantages as will be apparent from the following detailed description and accompanying figures.

### BRIEF DESCRIPTION OF THE SEVERAL VIEWS OF THE DRAWING(S)

FIG. 1 is a diagram illustrating a computer network implementation of the negotiation system described herein.

FIG. 2 is a functional block diagram illustrating an exemplary embodiment of a system designed in accordance with the present description.

FIG. 3 is a state machine model for simple fixed price sales.

FIG. 4 is an auction model state diagram.

FIG. 5 illustrates state transitions in generalized negotiations.

FIG. 6 is a party class diagram in accordance with the present disclosure.

FIG. 7 illustrates agent-system interaction for a registration process in accordance with the present disclosure.

FIG. 8 illustrates agent-system interaction for a transaction, request and disclosure process in accordance with the present disclosure.

FIG. 9 is a requisitioning and disclosure state diagram in accordance with the present disclosure.

FIG. 10 illustrates an access control and identity sharing model in accordance with the present disclosure.

FIG. 11 illustrates an access control and data sharing model in accordance with the present disclosure.

FIG. 12 illustrates a state diagram for a generalized negotiation model with disclosure in accordance with the present disclosure.

FIG. 13 illustrates an operational sequence for an initial listing in accordance with the present disclosure.

FIG. 14 illustrates an operational sequence for an intermediary interaction in accordance with the present disclosure.

### DETAILED DESCRIPTION OF THE INVENTION

The Internet introduces new opportunities to architect software systems that enable buyers, sellers and arbiters to conduct interactions electronically. The common feature of the software designed for electronic negotiation is that they are deployed on the world-wide web and capable of supporting, aiding one or more negotiators, mediators or facilitators. The present disclosure focuses on transactions specific to the corporate financial domain (mergers, acquisitions, investments, and divestitures), but the techniques described herein are universally applicable to all types of business transactions conducted over the Internet, where party identity and data disclosure are of strategic importance. The system and method of the present disclosure describe techniques by which potential buyers and sellers can perform a step-wise disclosure of corporate information while maintaining anonymity as to the true identity of the parties. That is, the parties can disclose increasingly confidential information to each other if there is sufficient interest by the parties.

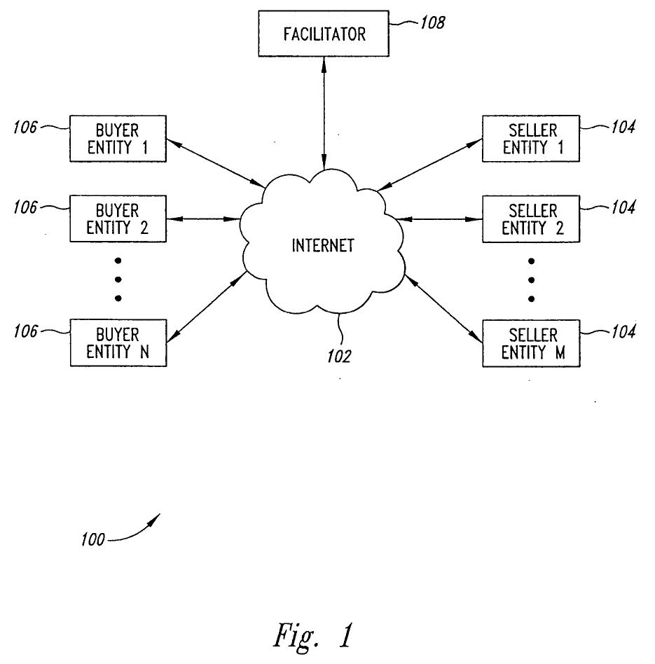

FIG. 1 illustrates a typical computer network implementation of a negotiation system 100 implemented in accordance with the description herein. Communication between the various parties is conducted over a computer network 102. The best known implementation of a wide area network is the Internet. Those skilled in the art will appreciate that the principles described herein are applicable to any computer network.

FIG. 1 illustrates a plurality of seller entities 104 as well as a plurality of buyer entities 106. Also illustrated in FIG. 1 is a facilitator 108 as will be described in greater detail below, a seller entity 104 communicates with the facilitator 108 via the Internet 102 to create a seller entity account. The seller entity 104 provides detailed information regarding the corporation. It should be noted that the various seller entities 104 are typically unrelated and may not even be involved in the same business. Similarly, the buyer entities 106 are typically unrelated and need not be involved in the same businesses. The seller entities 104 and the buyer entities 106 can be located in diverse geographic regions, involved in different businesses, have differing corporate structures (e.g., a partnership, LLC, corporation, and the like). The registration process will be described in greater detail below.

The term “seller entity” as used herein refers to any entity seeking to sell some or all of its assets or which is seeking a merger. The seller entity 104 illustrated in FIG. 1 represents a computer system operated by the seller entity for purposes of conducting the electronic transaction as described herein. For the sake of convenience, that system is labeled as the seller entity. Similarly, the term “buyer entity” refers to any entity seeking to purchase some or all of the assets of a seller entity or which is seeking a merger with a seller entity. The buyer entity 106 in illustrated FIG. 1 represents a computer system operated by the buyer entity for purposes of conducting an electronic business transaction as described herein. The term “facilitator” as used herein refers to an entity that arranges a business transaction between a buyer entity and a seller entity. In real estate transactions, a real estate agent may act as a facilitator to prepare a seller listing or to review seller listings on behalf of a buyer. In a similar manner, the facilitator 108 may function as a “middleman” to prepare listings on behalf of the seller entity 104 or to review listings on behalf of the buyer entity 106. In one embodiment, the facilitator 108 may refer to the computer system of an individual or company. In an alternative embodiment, the facilitator 108 may refer to a computer system programmed with software to perform the functions of a facilitator. Individuals trained in the operation of system 100 may function as the facilitator 108 to enter the necessary listing data described below.

Selected information related to the seller entities 104 is placed in an active sale list controlled by the facilitator 108. The buyer entities 106 may search the active sale list for possible sale opportunities. The buyer entities 106 may use search selection criteria to limit the search results. For example, the buyer entity 106 may limit searches to certain business types, certain business size, geographic limitations, and the like. Certain key word metatags may be associated with a buyer or seller to assist in the search process. For example, an electronics manufacturer may have metatags such as CD, DVD, or the like associated with its file to assist a potential buyer in the search process. Use of metatags in searching is well known in the art and need not be described in greater detail herein.

The buyer entity 106 may save search results with different filenames. In an alternative implementation, a search request from a buyer entity 106 may be stored by the facilitator 108 for automatic continuous searching by the facilitator. If a new seller entity 104 matches the selection criteria imposed by the buyer entity 106, the facilitator 108 may automatically send a match notification to the buyer entity to indicate the availability of a new seller entity that matches the selection criteria. Similar search capabilities are available to the seller entity 104.

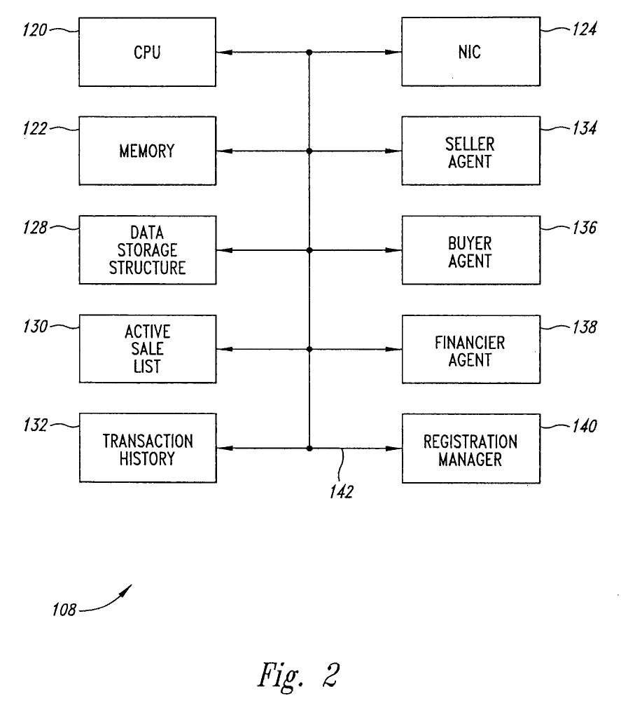

FIG. 2 is a functional block diagram illustrating an exemplary embodiment of the facilitator 108. The facilitator 108 is implemented in a computer system having a central processing unit CPU 120 and a memory 122. The CPU 120 may be implemented by any conventional processor, such as a microprocessor, microcomputer, or the like. The specific implementation of the CPU 120 is not critical to the operation of the system 100.

Similarly, the memory 122 may include random access memory (RAM), read-only memory, flash memory, and the like. The specific implementation of the memory 122 is not critical to the operation of the system 100. In general, the memory 122 contains computer instructions and data executed by the CPU 120.

The facilitator 108 also includes a network interface controller (NIC) 124 to control communications with the Internet 102. The NIC 124 may be any conventional interface, such as a telephone modem, cable modem, DSL modem, satellite modem, or the like. The specific implementation of the NIC 124 is not critical to the operation of the system 100.

The facilitator 108 also includes a data storage structure 128, which may be a portion of the memory 122 or a separate device, such as a hard disk drive, optical drive, or the like. The data storage structure 128 may be implemented in the form of a database implemented using conventional database software.

As will be described in greater detail below, the facilitator 108 includes an active sale list 130 in which information related to each seller entity 104 (see FIG. 1) is contained and may be searched by one or more buyer entity 106. The active sale list 130 may be part of the memory 122, the data storage structure 128, or a separate data storage structure.

The facilitator 108 also contains a transaction history storage area 132 that contains details of previous transactions between the seller entities 104 and the buyer entities 106. As will be described in greater detail below, the transaction history may be useful in current negotiations to assess a likelihood of success, establish pricing parameters, or the like.

Also illustrated in FIG. 2 is a seller agent 134, a buyer agent 136 and a financier agent 138. An agency relationship is one in which a person, the agent, acts on behalf of another with the authority of the latter. As will be described in greater detail below, the seller agent 134 is implemented as a software module and represents the interests of the seller entity 104. That is, the seller agent 134 acts on behalf of the seller entity 104 and operates within a set of rules established by the facilitator 108 and the seller entity to disclose information to a potential buyer. The seller agent 134 may be authorized by the seller entity 104 to disclose certain information related to the seller entity as part of the negotiation process. The seller agent 134 will only disclose information authorized by the seller entity 104. The authorization may be made in advance of a buyer request, or may require explicit authorization by the seller entity 104. The seller agent 134 at all times acts on behalf of the seller entity 104.

The buyer agent 136 performs similar tasks on behalf of the buyer entity 106. That is, the buyer agent 136 acts on behalf of the buyer entity 106 and operates within a set of rules established by the facilitator 108 and the buyer entity to disclose information to a potential seller. The buyer agent 136 may be authorized by the buyer entity 106 to disclose certain information related to the buyer entity as part of the negotiation process. The buyer agent 136 will only disclose information authorized by the buyer entity 106. The authorization may be made by the buyer entity 106 in advance or upon specific authorization request by the buyer agent 136. The buyer agent 136 may also be implemented by a software module operating in the facilitator 108.

It should be noted that FIG. 2 illustrates a single instance of a seller agent 134 and a single instance of a buyer agent 136. A single seller agent 134 may perform the necessary agency tasks for a single seller entity 104 or multiple seller entities, as shown in FIG. 1. Because the seller agent 134 is implemented as a software module, there is no conflict of interest if one or more of the seller entities 104 are competitors or have inherent conflicts in a negotiation process. Alternatively, the facilitator 108 may implement multiple instances of the seller agent 134 such that there is a one-to-one correspondence between instances of the seller agent 134 and the seller entities 104. Similarly, a single buyer agent 136 may act on behalf of one or more buyer entities 106. Because the buyer agent 136 is a software module, it can perform the agency tasks with respect to multiple buyer entities 106 with no conflict of interest. Although FIG. 2 illustrates a single buyer agent, those skilled in the art will appreciate that multiple instances of the buyer agent may be implemented in the facilitator 108.

The financier agent 138 may perform agency tasks on behalf of one or more financial institutions (not shown). The role of the financier agent 138 is to represent a financial institution in funding the transaction. A financial institution may be any entity capable of bankrolling a transaction, such as a bank, venture capital organization, investment organization, or the like. The system 100 is not limited by the form of financial institution represented by the financier agent 138.

The various components illustrated in FIG. 2 may be implemented in a variety of different system architectures. For example, the seller agent 134, buyer agent 136, and financier agent 138 are software modules that may be contained within the memory 102. However, these are illustrated as separate functional block diagrams in FIG. 2 because each implements a separate function. Furthermore, although the various elements of FIG. 2 are illustrated as portions of the facilitator 108, those skilled in the art will also recognize that distributed system architectures may also be used to implement the system 100. That is, various portions of the functional blocks illustrated in FIG. 2 may be physically located in one or more physical computer systems that comprise the facilitator 108. Alternatively, multiple instances of the facilitator 108 may be implemented with various portions of the software modules distributed across the multiple instances.

The various components illustrated in FIG. 2 are coupled together by a bus system 140, which may include an address bus, data bus, power bus, control bus, and the like. For the sake of convenience, these various busses are illustrated in FIG. 2 as the bus system 140.

Those skilled in the art will also appreciate that the system 100 may be implemented as a distributed system wherein an instance of the seller agent 134 may be implemented in each respective seller entity 104. Similarly, a separate instance of the buyer agent 136 may be implemented in each respective buyer entity 106. In such a distributed system, each seller agent 134 acts on behalf of its respective seller entity 104 while each buyer agent 136 acts on behalf of its respective buyer entity 106. Relevant corporate data for the seller entities 104 and the buyer entities 106 may be stored locally within each respective seller entity and buyer entity or stored in the common location, such as the facilitator 108.

Those familiar with computer system architecture will recognize that numerous other implementations are also possible. The system 100 is not limited by the specific architectural implementation. Regardless of the specific system architecture, corporate information is still disclosed only when authorized by the respective seller entity 104 or buyer entity 106, as will be described in greater detail below.

### Overview of Current Models of Electronic Negotiations

We begin with a brief description of Electronic Negotiation and discuss the software models that abstract parties and their interactions. The notion of pseudo identity will be introduced subsequently. The system 100 includes a mechanism to map true identity to a pseudo identity, as well as a system to manage disclosure (of data and identity) in a multi-party negotiation scenario.

Systems to facilitate business negotiations have been studied by various researchers. Most systems define common components of a negotiation as a “negotiable deal” which is modified by the “participants” in the negotiations with the aim of reaching a “final deal” or “trade.” Consequently the five key elements of a negotiation process are:

1. A deal—which can be in various states such as negotiable, final offer from buyer or seller, or a settled trade.

2. Participants—such as buyers, sellers, auctioneers, brokers, etc.

3. Messages sent by the participants to modify the deal. Examples of messages are bids, offers to buy or sell, and price changes.

4. Process flow describing how the state of the deal changes as a result of the messages sent by the participants.

5. Messages sent to the participants as the deal changes.

As described in greater detail herein, the facilitator 108 provides a trading platform to implement each of these components to thereby facilitate the business transactions. In addition, a platform encodes within it the “rules of engagement” for transacting parties.

### Negotiation Interaction Models—Finite State Machines

Negotiations have traditionally been modeled as a finite state machine (FSM). The states of the FSM are states of the deal. While “negotiable” or “non-negotiable” are different states of the deal, different bid or asking prices do not create different states of the deal. They are simply attempts at transitioning from a given state to another. The input nomenclature of the FSM is the set of messages that can be possibly sent by the participants, expressed as a pair <participant, input-message> where participant is the sender of the message. For instance, a buyer making a bid is represented as <buyer, Bid>. A seller accepting a bid and closing the auction is represented as <seller, Auction Close>.

The output nomenclature of the FSM is the set of messages sent to participants. These messages are also expressed as a pair <<participants, output-message>> where participants form a subset of all participants that will receive the output-message (outbound messages are placed in double angular brackets to distinguish them from the inbound messages). The process flow of the negotiation maps into the state transition rules of the FSM. The following section describes an interaction in its simplest form, one with no negotiation among parties—a fixed price sale.

### Fixed Price Sale

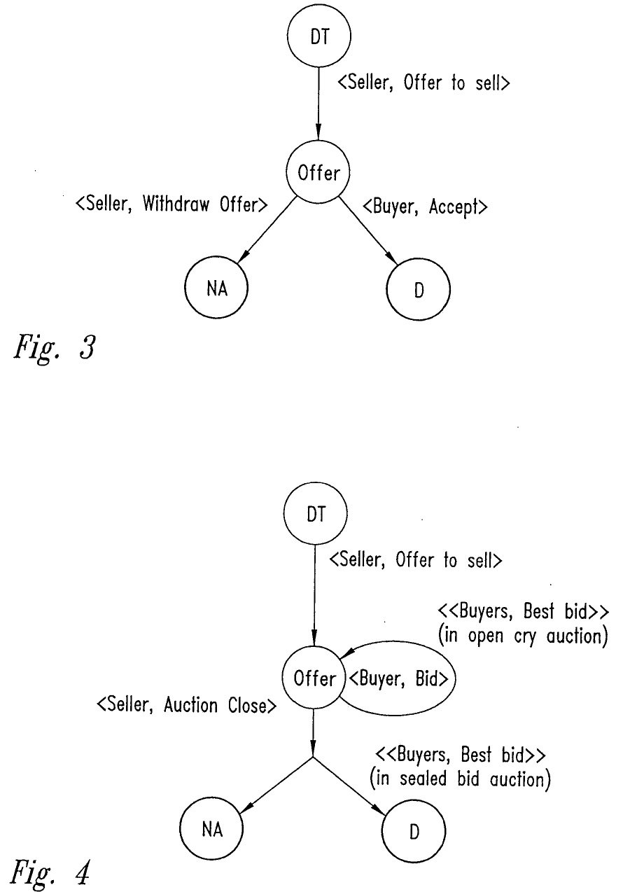

FIG. 3 illustrates a state diagram for a fixed price sale. The states illustrated in FIG. 3 are deal template (DT), offer to sell (Offer), negotiation aborted (NA), and deal (D), respectively. The offer-to-sell message from a seller creates an offer that can either be accepted by a buyer to conclude the deal or can be withdrawn by the seller to abort the negotiation.

### Auction Sale

A more complicated negotiation scenario can be observed in auctions. FIG. 4 shows the negotiation process in a simple open cry and sealed bid auction. As in a fixed price sale, the seller starts by creating an offer to sell. However, unlike the fixed price sale model this offer does not immediately transition into a final sale (i.e., the deal state). While the auction is in the offer state the buyers can submit bids, which results in a transition back to the offer state.

In an open cry auction this transition creates an outbound message to all buyers containing the current best bid while in a sealed bid auction no information is fed back. The negotiation process ends with the seller closing the auction at a time based on pre-agreed rules such as at a previously agreed time, or after certain duration of inactivity, or a combination of the two. There is a deal if there is at least one bidder and the highest bid exceeds the reserve price (if the bidder has specified one).

### Towards a More Generalized Negotiation Model

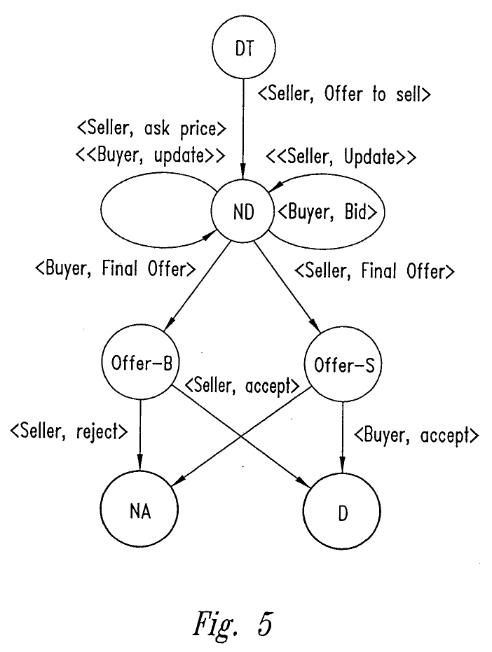

The models in FIGS. 3-4 described above demonstrate the range of complexity in business interactions from simplistic to the moderately intricate. Real negotiations, on the other hand, are far more complex. A two party negotiation model shown in FIG. 5 is essentially a hybrid of auctions and fixed price sales. It starts as an auction and request for quote (RFQ) procurement model combination where either the buyer or seller can start a negotiable deal, the ND state in FIG. 5. The deal would contain both the seller's asking price and/or the buyers bid, and either party can modify their position. As previously discussed, changes in asking price and/or bid price do not change the current state of the negotiation process. That is, the process remains in the ND state so long as neither party has made a final offer. From this state, either the buyer or seller can create his final offer, Offer-B and Offer-S respectively, similar to the transition to the offer state in FIG. 3. If the seller initiates the final offer, he can withdraw it or the buyer can accept it as in FIG. 3. If the buyer initiates the final offer he can withdraw it or the seller can accept it.

The generalized negotiation model introduced above captures the most well understood process in business interactions, namely pricing. The eventual goal of a successful negotiation is to settle on a price acceptable to both parties.

### Use of Software Agents in Electronic Negotiations

The first step towards modeling electronic negotiations is defining the elements that capture interacting parties. These act as the electronic surrogates to the real world entities. This process may be readily understood through the use of software agents to model parties.

Software agents are programs or program modules to which one can delegate (aspects of) a task. They differ from traditional software in that they are personalized, continuously running and semi-autonomous. These qualities make agents useful for a wide variety of information and process management task. Software agents form the basis for the information-rich and process-rich environment of electronic negotiations systems. We focus on two such types of negotiation agents—buyer agents 136 (see FIG. 2) and seller agents 134. Further, we briefly discuss the role of a third type of agent—the financier agent 138.

Intermediary agents (both buyer and seller) primarily facilitate collaboration among parties they each represent in negotiations. Therefore they are given access to software functions based on the party they represent. For example, buyer agents 136 (see FIG. 2) have access to functions that enable them to fulfill their primary role of agent for the buyer entity 106 (see FIG. 1).

Buyer agents 136 representing the buyer entity 106 in a negotiation, provide the following services—
Assisting the buyer in defining his acquisition criteria
Developing lists of prospective target companies through the use of databases and other reference sources
Approaching the target companies on behalf of the buyer to ascertain their willingness to consider acquisition
Developing information to assist the buyer in analyzing target companies
Assisting in arranging financing needed to bring about the transaction
Assisting in the valuation, structuring and consummation of the acquisition transaction

Although shown in FIG. 2 as a single functional block, buyer agents 136 may comprise multiple programs that capture, streamline and manage the above data and services. Each buyer entity 106 logged into the system 100 is assigned a buyer agent 136 from a pool of worker threads. Worker threads refers to a series of software programs that execute in parallel. The worker threads simultaneously serve buyers and/or sellers. In addition to managing the buyer data structures (see buyer schema below), this buyer agent 136 facilitates access to the following functions—
Functionality—Search, Browse and Compare Acquisition Targets
Buyer Schema—Data Structures capturing
   Identity
   Buyer Information
      Industry
      Size
      Locations
      Financing Capabilities
      Marketing Material
      Corporate Financial Statements
      Statement of Authority (Legal Documents)
      Personnel
   Acquisition Criteria
   Company Search

The seller agents 134 (see FIG. 2) representing the seller entity 104 (see FIG. 1) in a negotiation, provide the following services—
Determining the value of the business to be sold
Preparing an information package describing the company to be sold
Identifying and ranking qualified prospective buyers
Approaching prospective buyers on behalf of the seller on a confidential basis
Assisting the seller in evaluating offers and negotiating terms of the transaction
Facilitating consummation of the transaction in conjunction with the seller's legal, real estate and tax advisors

Seller agents 134 are similar to the buyer agents 136 in their use of the underlying agents infrastructure. However, functionally, they are programmed to capture, streamline and manage data and services of importance to the seller, such as the following—
Functionality—Add, Update Listing and Upload Sell side collateral
seller Schema—Data structures capturing
   Identity
   Seller Listing Information
      Marketing Material
      Corporate Financial Statements
      Statement of Authority (Legal Documents)
      Personnel
      List of Excluded Buyers

The financier software agents 138 (see FIG. 2) are similar to the buyer agents 136 in both their usage of the infrastructure as well as their functionality. Financiers are typically buyers of equity (share of the company) and therefore have a lot in common with buyer agents. They use essentially the same tools available to the buyer agent 136 in making an investment decision.

### Data Model

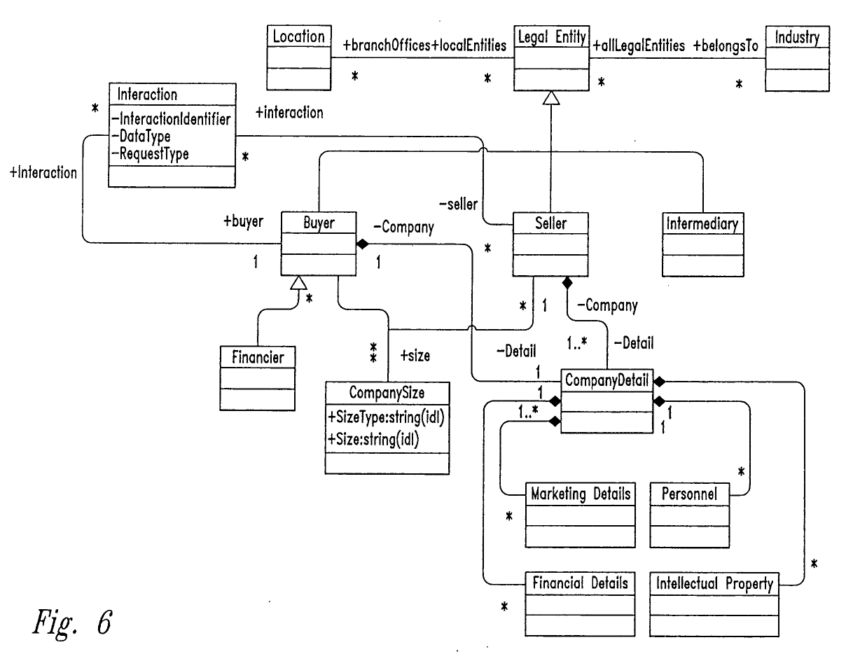

The data model attempts to capture all data elements critical to evaluating, buying and selling of companies or its assets. FIG. 6 illustrates the relationship between the agents defined in the system. It should be noted that FIG. 6, and other figures in the present disclosure, are drafted using unified modeling language (UML) to illustrate the operation of the system 100. The use of UML is intended to assist in the description of the system. However, the use of UML is not intended as any limitation on the scope of the present disclosure. UML nomenclature is well known and need not be discussed in detail herein.

As shown in FIG. 6, all the data elements common to buyers entities 106, seller entities 104, their respective agents (i.e., the buyer agent 136 and the seller agent 134, respectively), and financiers (such as Location, Industry domain) are abstracted into a Legal Entity. Thus, all of the agents are defined as top-level Legal entities and as such “inherit” all of the data elements and functionality.

Furthermore, the data model allows for the capture of elements specific to each type of agent. Buyer and seller data structures store company details, such as Financials, Marketing material, Intellectual Property and Personnel information. In one embodiment, the seller agent 134 (see FIG. 2) and buyer agent 136 may comprise internal data structures to store company data related to the seller and buyer, respectively. Alternatively, such data may be segregated and stored in the data storage structure 128 in the facilitator 108. The particular physical location of data storage is not critical to successful operation of the system 100. Controlled access and disclosure of information is important to successful negotiations, as will be described in greater detail below.

An interaction element illustrated in FIG. 6 controls the flow of information between buyer and seller. An interaction identifier is a number generated by the system 100 to uniquely identify a particular interaction. A Request Type refers to the type of information being requested by a party. This request may include various types of corporate data and may also include a request for party identity. The Request Type captures this information and ties it to a particular interaction. A Data Type refers to the form in which data may be requested or delivered. For example, requested data can be in several forms, such as audio, video, text media types, and the like. The Data Type captures the specific form of the data. In an exemplary embodiment the seller entity 104 or buyer entity 106 could include a video clip or other multimedia presentation as part of the material to be disclosed. For example, the seller entity 106 may include a video clip with a tour of the manufacturing facility, laboratory, or the like as well as introductions to key personnel. The specific form of the video clip or multimedia presentation may vary based on the type of business.

### Party Identity and Disclosure in Negotiations

Agents, as noted earlier, each perform specific functions in a negotiation. Agents exchange data (see Data Model above) on behalf of their respective parties as they interact. Of all data, the one most critical to a negotiation is Identity. Preserving the privacy and the security of the parties as they interact is critical. The system 100 includes rules governing this exchange among the parties and includes a process to maintain privacy as well as a mechanism to allow secure sharing of identity.

True identity holds strategic value in any interaction. For example, in a negotiation between a buyer and a seller, knowledge of the buyer's identity can drive up the price of the item. Therefore the system 100 includes a process that discloses only the information needed to carry out the transaction as the parties conduct negotiations. The identity of the parties is kept private during all exchanges. Anonymity is crucial and identity is revealed only by request and on authorization from the concerned party.

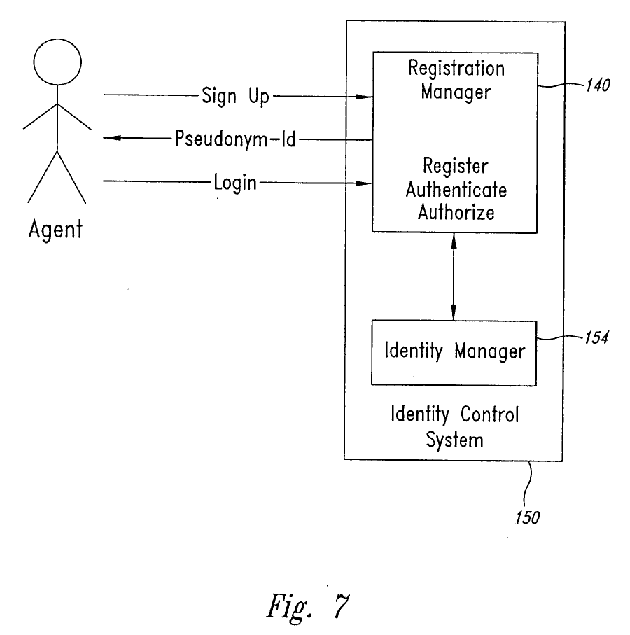

The mechanism to separate identity and interaction is built into the system, henceforth referred to as an identity control system 150 illustrated in FIG. 7. The identity control system 150 preserves identity by assigning and using pseudo identity in its place until the party is ready to reveal its true identity. The design of the identity control system 150 also streamlines the requisitioning and disclosure of identity.

When a seller entity 104 (see FIG. 1) or a buyer entity 106 initially contacts the facilitator 108, a registration process is initiated. All seller entities 104 and buyer entities 106 are required to register with the identity control system 150. This invokes a registration manager 152 that captures relevant data and designates the seller entity 104 or the buyer entity 106 and creates the seller agent 134 or buyer agent 136 to act on behalf of the seller entity or the buyer entity, respectively. The registration manager 152 also assigns system-defined identifiers to all registrants. In an exemplary embodiment, the identifiers comprise alphanumeric data that is tied to a registered party. The identifiers enable the system and all users to uniquely identify each entity. For example, a portion of an identifier, such a prefix, may identify a merger/acquisition entity using an identifier such as MA-3465534 where the “MA” identifies the type of entity (i.e., a merger/acquisition entity) while the numeric portion of the identifier may be randomly assigned to protect the identity of the entity. In an alternative embodiment, the entire alphanumeric sequence may be randomly generated or generated using a secure algorithm so as to protect the true identity of the entity. These identifiers are public and viewable to all the parties. Thus, system identifiers are the elevated to the status of digital pseudonyms. The seller agent 134 and buyer agent 136 in all subsequent interactions must use these identifiers for authentication and authorization with the system. An identity manager component 154 handles the generation and management of pseudonyms.

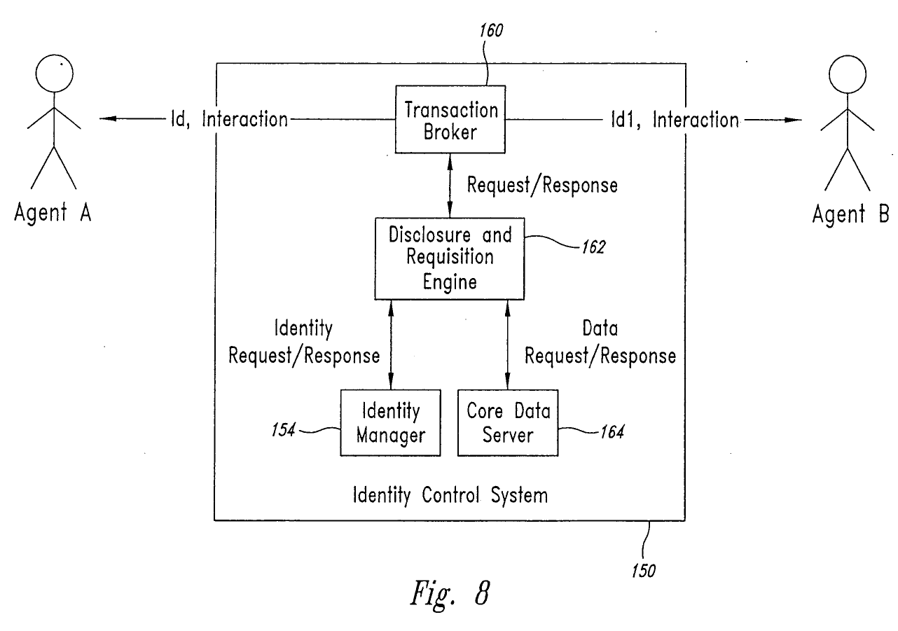

Typical interactions, especially in the early stage of negotiations are carried out using party pseudonyms. FIG. 8 illustrates the operation of the identity control system 150 in the initial exchange of information between parties. FIG. 8 illustrates an exchange of information between two agents, identified as Agent A and Agent B. It can be appreciated that Agent A in FIG. 8 may be either the seller agent 134 (see FIG. 2) or the buyer agent 136. Similarly, the role of Agent B could be fulfilled by either the seller agent 134 or the buyer agent 136. For example, FIG. 8 illustrates interactions via a transaction broker 160 the buyer agent 136 asking for the seller agent 134 to disclose Financial Income Statements or Personnel information. Through the life cycle of these interactions, the identity or brand of the agent (i.e., the seller agent 134 and the buyer agent 136) as well as the identities of the parties they represent (i.e., the seller entity 104 of FIG. 1 and the buyer entity 106) remains its system-defined pseudonym. In this sense, the transactions are not completely anonymous as there is a persistence of identity, albeit pseudo, across buyer agents, seller agents and their interactions.

As noted earlier, registered agents (either the seller agent 134 or the buyer agent 136) can request the system 100 to provide data relevant to a negotiation. All such requests are recorded by the transaction broker 160 and passed through to a Disclosure and Requisitioning Engine 162. The disclosure engine 162 in turn locates the appropriate agent that owns the data (such as its Financial Statements) and submits a “Request for Disclosure” to a core data server 164. The core data server operates to control access to the data structure containing the requested information. As previously noted, the data structure containing the requested information may be stored as part of the seller agent 134 (see FIG. 2), the buyer agent 136, or the data storage structure 128 of the facilitator 108. Whichever agent controls the requested information may be designated as the “owning” agent. The owning agent can then configure the engine to either grant access or otherwise disclose in part or in its entirety, or decline the request. Thus, the disclosure engine 162 essentially mediates access between the requesting and owning agents.

As previously noted, the transaction history 130 (see FIG. 2) stores all data relevant to all negotiations processes. The transaction broker 160 records all requests for information, as noted above. The request for information, responses to the requests, and exchanged information may all be stored as part of the transaction history 130.

As parties exchange data relevant to the deal, there is a point in the lifecycle of the negotiation where all the variables align and to move forward, the parties need to disclose their true identity. The disclosure engine 162 also provides a mechanism for intermediary agents (either the seller agent 134, the buyer agent 136, or both) to interrogate each other for true identity via the use of the identity manager 154. Depending on the type of access being requested, identity vs. core data, the disclosure engine 162 delegates the function to either the identity manager 154 or the core data server 164. As previously discussed, the true identity of any party requires the express authorization of the respective entity.

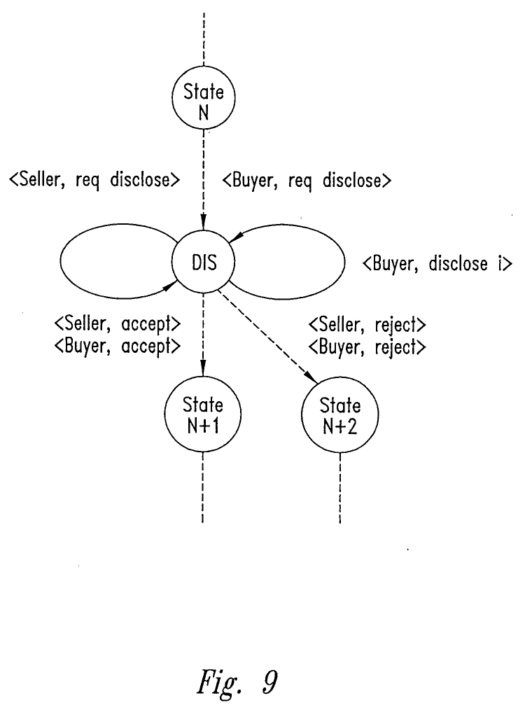

FIG. 9 describes the requisitioning and disclosure state diagram used by the disclosure engine 162. And agent (either the seller agent 134 or the buyer agent 136) can request disclosure, which moves the state machine into the Disclose state. While in the Disclosure state, either party can disclose information they own (including, but not limited to identity), and with each disclosure the negotiation moves close to a deal. Eventually, if both parties are satisfied the machine moved to the next state (State N+1). It should be noted that the state “N+1” and state “N+2” are intended to refer generically to a next step in the sequence of states that may vary based on the particular state diagram. (E.g., see FIGS. 3-5.)

The disclosure transitions can occur at any stage in the negotiation. The identity control system 150 makes this disclosure configurable. The following section describes in details the rules that form the basis of sharing identity.

### Sharing and Assigning Disclosure Rights

The system 100 defines the basic “rules of engagement” for negotiating agents (typically intermediaries). The following rules govern their interaction in requesting disclosure and sharing identity.

1. Agents encapsulate (own) data, (i.e., an agent has access to all its data elements) related to the entity which it represents. This includes identity information.

2. Agents can be authorized to disclose data. However, agents may not disclose unless explicitly granted this privilege by the owner. Authorization may be granted on single or multiple data elements.

3. Buyer and seller agents are typically constrained to disclose data they directly own (encapsulate). Therefore, the buyer agent 136 may only disclose data about the buyer entity 106 that it represents.

4. Agents can request other agents to disclose data.

5. Agents may share data that is available to them indirectly, but only if permitted by the direct owner of the data. For example, if the seller agent 134 has been made aware of the identity of the buyer entity 106 via a “legal disclosure”, it may not share this information with other agents (e.g., the financier agent 138) unless it obtains a separate permission from the buyer agent 136. In other words, the Data Sharing Policy implemented with the identity control system 150 dictates the following—Only the direct owner intermediary can disclose or authorize disclosure of data they encapsulate.

### Implementing Identity Sharing Policy

As discussed above, each legal entity (buyer or seller) has associated with it a secure data structure capturing its true identity as well as the corresponding system generated pseudo identity. The identity control system 150 (see FIG. 7) also maintains an identity access control list (iACL) for all registered entities. For any given entity participating in a negotiation, its iACL is simply an enumeration of those agents that have access to its true identity. Intermediaries have the right to modify the list associated with the party they represent.

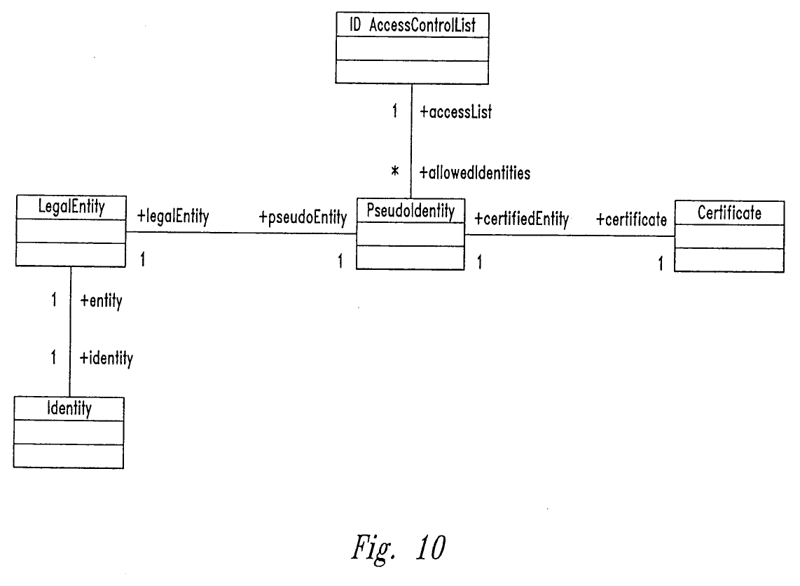

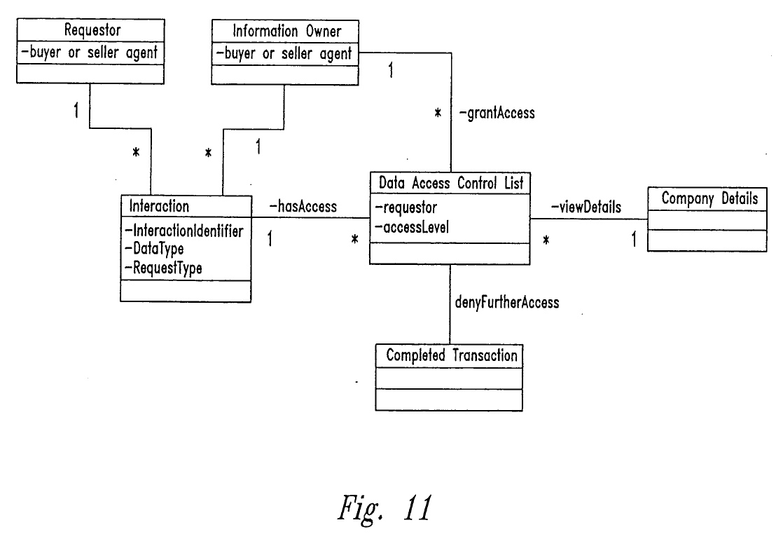

FIG. 10 is a model that captures the relationship between a legal entity and its iACL. A Legal Entity in the context of a negotiation can have one and only one iACL. As previously discussed, a Legal Entity refers to buyers, sellers, or financiers. The true identity and pseudo identity of these various entities have been previously discussed as well. The certificate refers to a digital certificate. Those skilled in the art will recognize that a digital certificate provides a means of proving identity in transactions. The certificate binds an identity to a pair of electronic keys that can be used to virtually “sign” an electronic interaction. As discussed above, the iACL identifies entities (e.g., the seller agent 134) and enumerates which agents have access to its true identify.

### Implementing Data Access Control

FIG. 10 illustrates a model for operation of the system 100 to control access to true identity. FIG. 11 performs a similar function to control access to other types of corporate data. Instead of an Identity Access Control List (see FIG. 10), the system 100 contains a data Access Control List (dACL), which controls access to company details that may be disclosed in a step-wise fashion if authorization is granted.

In a typical exchange, the seller agent 134 or the buyer agent 136 takes the role of a requestor and initiates an interaction by requesting a data item. The Requestor data element in FIG. 11 stores a pointer to the buyer entity 106 (see FIG. 1) or the seller entity 104 already registered with the system 100. This request is passed on to the information owner by the system 100. In response the owner grants or denies access to its corporate details by appropriately modifying the data access control list (if access has not already been granted). This access remains active until the deal is complete or until the owner chooses to deny further access. FIG. 11 captures the static data structures required to provide fine-grained corporate data access control. Each interaction is between exactly one requester and one owner. A single interaction can result in the owner granting access to one or more of its data items (company details) by creating an entry in the data access control list structure.

The dACL, therefore, acts as a filter employed by the Information Owner to grant selective access to its information, stored in Company Details data structure. Finally, FIG. 11 also captures the completion of a transaction so that the system can choose to prompt the information owner to take appropriate action, such as denying further access to the Requestor. All of the aforementioned actions exercise one or more of the data structures in FIG. 11. The data structure introduced in FIG. 11 supports a Data Access Console to tie all the actions, related to access Control and step-wise disclosure of data, together into a single user interface.

In this section we take the generalized negotiation model described earlier and modify it to include disclosure states. We then apply this model to streamline the Mergers, Acquisition and Corporate financing domain.

### A Modified Generalized Negotiation Model

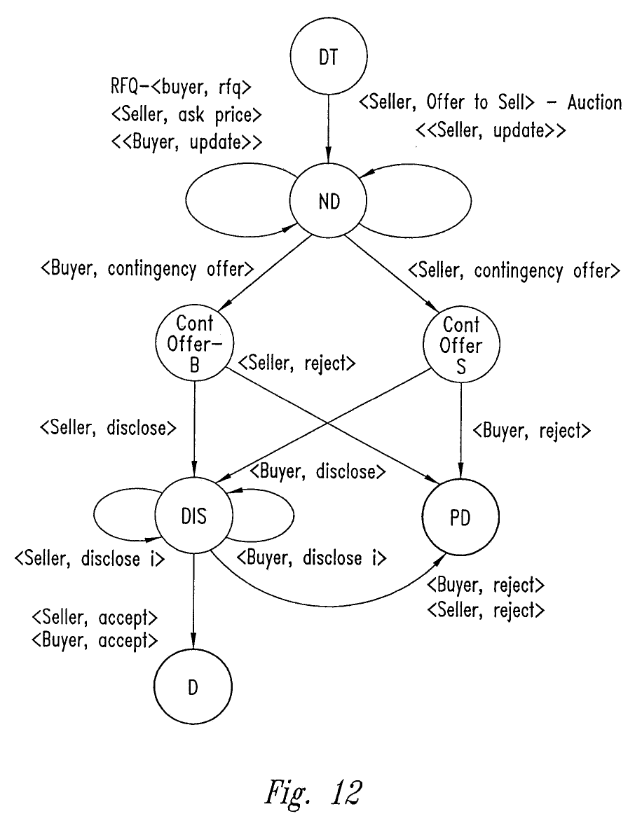

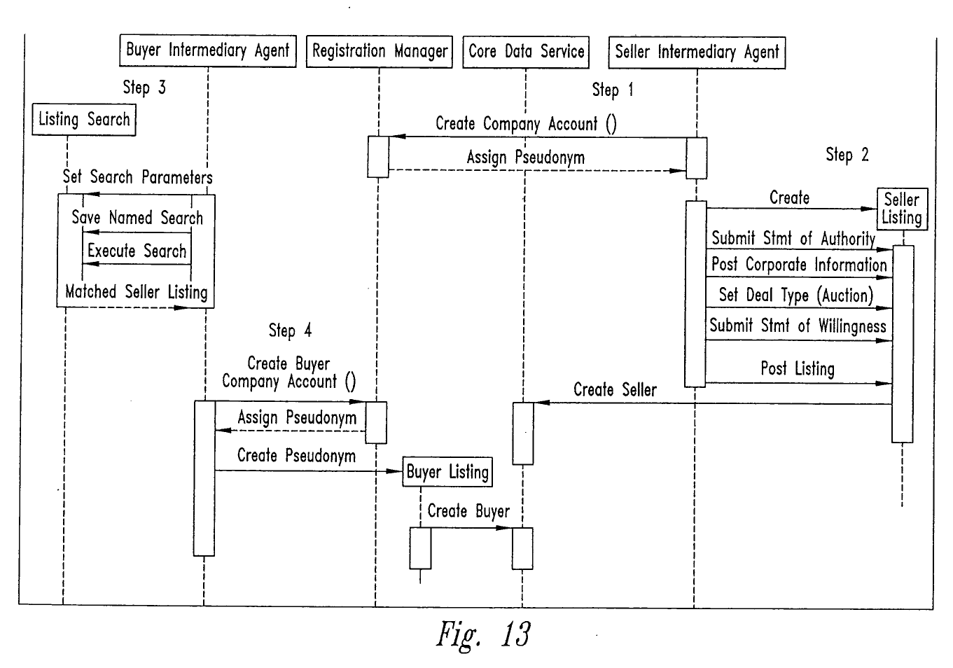

FIG. 12 demonstrates the use of disclosure in the generalized negotiation model introduced in FIG. 5. In this example, disclosure is the final stage in the negotiation process and occurs once a state of “Contingency Offer” is reached. From this state the buyer or seller can request the other party to disclose data. If the request is granted, and further disclosure is requested, the state machine comes back to the Disclosure state to allow negotiations to continue using the newly disclosed information. The state machine moves to the next state, Deal, when both parties are satisfied with the disclosure. However, if either party rejects disclosure, the FSM moves to a Partial Disclosure (PD) state to allow negotiations to progress, if possible, without disclosure of the requested information.

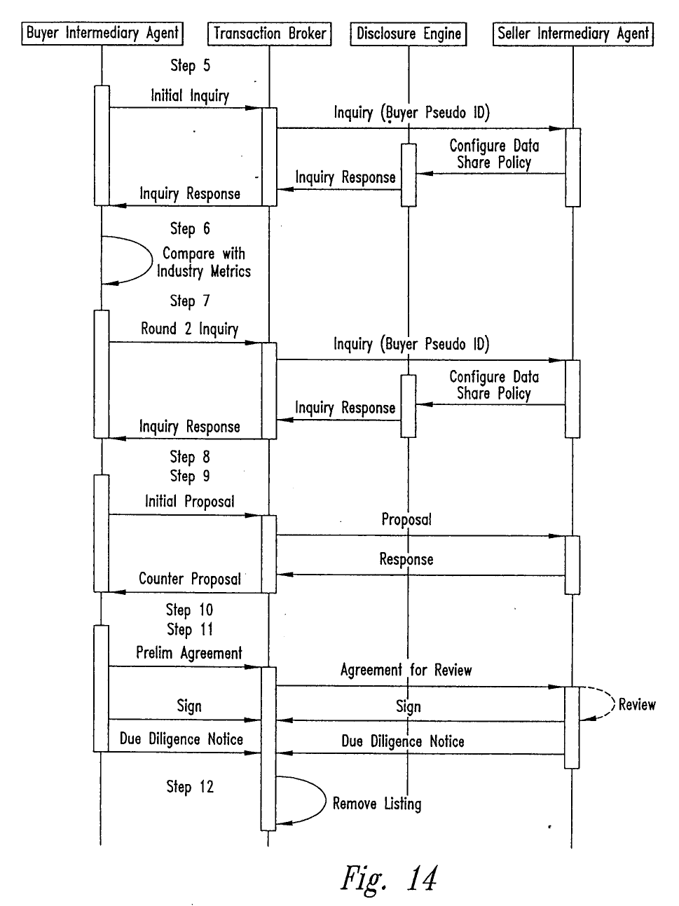

The system 100 described herein streamlines the sequence of interactions for the merger and acquisition (M & A) domain, using the various qcomponents and models described earlier in the document. A series of steps to be followed in “making a deal” is described using a pair of UML sequence diagrams shown in FIGS. 13 and 14.

FIG. 13 describes the initial steps to be followed by intermediary agents (i.e., the seller agent 134 and the buyer agent 136) in interacting with the system 100 in performing the following activities:
Make Initial Inquiry
Create Seller Listing
Save Buyer Search Criteria
Create Buyer Listing

As discussed above, the system 100 provides search capabilities to permit the intermediaries (i.e., the seller agent 134 and the buyer agent 136) to electronically search listings for compatible targets. As with purchase and sale processes described above, the search mechanism provided by the system allows searches to be saved individually with the searcher applying appropriate file names for subsequent retrieval. The system also permits automatic ongoing searches that compare new listings with existing search criteria. If a new listing matches the search criteria, a message, such as an email, may be automatically generated and sent to the party having initiated the search.

The system 100 has been described above with the seller entity 104 (see FIG. 1) and buyer entity 106 create the respective listings for storage, by way of example, by the facilitator 108. This technique may be termed a “push” model because the seller entity 104 “pushes” its data toward the facilitator 108. Similarly, the buyer entity 106 pushes its data to the facilitator 108. However, the system 100 also accommodates a “pull” model to create additional marketing opportunities. For example, a transaction specialist can monitor the active sale list 130 (see FIG. 2) for information of interest to an entity which it represents. The transaction specialist may be an individual or part of a corporate entity. In one example, a transaction specialist represents the seller entity 104 and aids in the creation of the sale listing. Similar transaction specialists may represent the buyer entity 106. In a pull model, a transaction specialist may monitor the active sale list 130 to identify listings of interest to companies that the transaction specialist represents or that the transaction specialist may want to represent. For example, a buyer entity 106 may be interested in acquiring a DVD manufacturer in California. The buyer entity 106 may enter the data into the active sale list 130 directly or using a transaction specialist.

A different transaction specialist searching the active sale list 130 may discover the buyer entity listing. In a push model, a seller entity 104 would already be listed on the active sale list 130 and matched to the specifications of the buyer entity 106. In a pull model, a transaction specialist may be aware of DVD manufacturers that fit the buyer entity criteria, but which are not yet listed on the active sale list 130. In this pull model, the transaction specialist may seek out companies that match the buyer entity criteria and recruit a seller entity to list the seller entity using the system 100. Thus, the transaction specialist “pulls” the seller entity into the system 100.

The pull model may also be applied to buyer entities. That is, a transaction specialist may see a seller entity listing on the active sale list 130 (see FIG. 2) and attempt to recruit a buyer entity that is not yet active within the system 100 (i.e., not on the active sale list 130). Thus, the transaction specialist “pulls” the buyer entity into the system 100. Thus, the system 100 may be efficiently utilized to draw buyers and sellers into the marketplace.

Once a target has been identified, negotiations may begin between the parties using their intermediary agents. FIG. 14 describes the subsequent negotiations between both agents (i.e., the seller agent 134 and the buyer agent 136) brokered by the system 100. The following sequence is captured:
Make Initial Inquiry
Record inquiry response
Inquiry Round 2
Record inquiry response
Proposal Phase
Proposal Acceptance stage
Capture Preliminary Agreements
Due Diligence Phase

The sequence diagrams of FIGS. 13-14 depict agent interactions in a simplistic single buyer—single seller agent setting. Those skilled in the art will appreciate that the identity control system 150 (see FIG. 7) is capable of supporting higher degrees of complexity associated with multiple, simultaneous, buyer—seller interactions. This may include, by way of example, multiple buyer entities 106 (see FIG. 1) pursuing a single seller entity 104 or a single buyer entity pursuing multiple seller entities. The system 100 may also be implemented to permit multiple buyer entities 106 to join together to negotiate with one or more seller entities 104. Furthermore, the steps in FIGS. 13-14 are only an outline of a typical scheme of interactions. For example, the data and identity disclosure step can be interwoven into any stage in the sequence.

### Negotiated Deal and Closure

Successful negotiations culminate in deals and the parties involved document critical elements of the interactions. The final state of “closure” is characterized by a preliminary agreement that is reached between the negotiating agents. In this section we focus on the various modalities available in the identity control system 150 for capturing the components of this preliminary agreement.

### Preliminary Agreement Components

Typical agreements capture the following information:
Documentation of purchase of assets
Assumption of liabilities
Price Negotiated
Closing
Access
Non-Compete terms
News release
Public announcements
Exclusivity period
Representations
Warranties
Contingencies

Towards facilitating the final step in the negotiation, the closure, identity control system 150 (see FIG. 7) contains one or more pre-packaged agreement templates that will allow for the capture of any or all of the above elements. Parties entering the final phase of the negotiation will have the ability to collaboratively customize instances of these templates to reflect their negotiation. These customized versions can then be shared it amongst authorized parties.

Similarly, a template is also provided to initiate the very first step in the negotiation process, namely the Non-Disclosure Agreement. This governs the authority of agents to share information.

### Tracking Closure and Deal History

After the preliminary agreements are drawn up the parties move the deal into escrow. The identity control system 150 provides data structures to capture the milestones and final closing date set in the escrow process. This enables the deal to be tracked through to completion.

Upon completion, the data generated as a part of the negotiation process is removed from the transactional system and added to the transaction history 130 (see FIG. 2). The transaction history 130 serves as a repository enabling mining of interesting statistics such as ratings of buyer, sellers, and intermediaries.

Thus, the system 100 allows complex negotiations between multiple parties and includes necessary precautions that govern the disclosure of data and the progress of negotiation. The use of automated software agents (i.e., the seller agent 134 and the buyer agent 136) assure proper confidentiality during the negotiation process. The flexible architecture of the system 100 allows centralized implementation using, by way of example, the facilitator 108 (see FIG. 1) or a distributed implementation wherein the software agents or portions thereof reside in multiple computer systems such as, by way of example, the computer system associated with the entity that the agent represents.

At each point in the negotiation process, the entities can be assured that their respective agents are acting on their behalf and will only take authorized actions. The security system provide by the identity control system 150 assures anonymity of the parties during the negotiation process. The ability to track negotiations using pseudo identities allows continuity in discussions between the parties.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-readable medium whose contents control an electronic transaction for sale of a seller entity to a buyer entity, by causing a processor to:
store seller entity data received from a seller entity, including seller entity identification data and seller entity contact information and corporate information related to the seller entity;
store buyer entity data received from a buyer entity, including buyer entity identification data and buyer entity contact information;
receive a buyer entity inquiry regarding a seller entity listing, the seller entity listing including a portion of the seller entity data;
receive a seller entity decision regarding responding to the buyer entity inquiry;
disclose an additional portion of seller entity data to the buyer entity if the seller entity decision is to respond to the buyer entity inquiry;
repeat the receiving a buyer entity inquiry and receiving a seller entity decision; and
disclose additional portions of seller entity data to the buyer entity so long as the seller entity decision is to respond to the buyer entity inquiry.

2. The computer-readable medium of claim 1, further comprising instructions to cause the processor to receive a proposal from the buyer entity or the seller entity and to receive a response to the proposal.

3. The computer-readable medium of claim 2 wherein the response indicates an acceptance of the proposal, the computer-readable medium further comprising instructions to cause the processor to:
generate an agreement for acceptance by the buyer entity and the seller entity; and
remove the seller entity listing.

4. The computer-readable medium of claim 2 wherein the response indicates a refusal of the proposal, the computer-readable medium further comprising instructions to cause the processor to terminate authorization of the disclosure of additional portions of seller entity data.

5. The computer-readable medium of claim 1 wherein the seller entity selects the portion of the seller entity data for the seller listing in the form of standardized seller entity company description data.

6. The computer-readable medium of claim 5 wherein the seller entity decision is to respond to the buyer entity inquiry and is made in advance of the receiving the buyer entity inquiry regarding the seller entity listing, the computer-readable medium comprising further instructions that cause the processor to automatically disclose the additional portion of seller entity data to the buyer entity upon receiving the buyer entity inquiry.

7. The computer-readable medium of claim 1 wherein the seller entity selects the additional portion of seller entity data to disclose to the buyer entity.

8. The computer-readable medium of claim 7 wherein the seller entity decision is to respond to the buyer entity inquiry and is made in advance of the receiving the buyer entity inquiry regarding the seller entity listing, the computer-readable medium comprising further instructions that cause the processor to automatically disclose the additional portion of seller entity data to the buyer entity upon receiving the buyer entity inquiry.

9. An electronic transaction system for a transaction between a seller entity to a buyer entity comprising:
a first data structure configured to receive and store information; and
a seller agent program module configured to:
store information related to the seller entity in the first data structure;
post a seller entity listing to an active sale list, the seller entity listing including a portion of the seller entity information from the first data structure;
receive a buyer entity inquiry regarding the seller entity listing;
disclose an additional portion of seller entity information from the first data structure in response to the buyer entity inquiry if authorized to respond to the buyer entity inquiry; and
repeat the receiving a buyer entity inquiry and disclosing additional portions of seller entity information from the first data structure to the buyer entity so long as the seller agent is authorized to respond to the buyer entity inquiry.

10. The system of claim 9 wherein the seller agent is authorized to disclose the additional portion of seller entity information in advance of the receiving the buyer entity inquiry, the seller agent automatically disclosing the additional portion of seller entity information upon receiving the buyer entity inquiry.

11. The system of claim 9 wherein the seller agent is further configured to communicate with the seller entity upon receiving the buyer entity inquiry to thereby obtain seller entity authorization to disclose the additional portion of seller entity information.

12. The system of claim 9 wherein the buyer inquiry includes a request for identification of the seller entity, the seller agent being further configured to communicate with the seller entity upon receiving the buyer entity inquiry to thereby obtain seller entity authorization to disclose the seller entity identity.

13. The system of claim 9, further comprising:
a second data structure; and
a buyer agent program module configured to:
store information related to the buyer entity in the second data structure;
query the active sale list to identify the seller entity listing;
generate the buyer entity inquiry regarding the seller entity listing;
receive an additional portion of seller entity data from the first data structure in response to the buyer entity inquiry if the seller agent is authorized to respond to the buyer entity inquiry;
receive a seller entity inquiry regarding the buyer entity; and
disclose a portion of buyer entity data from the second data structure in response to the seller entity inquiry if the buyer agent is authorized to respond to the seller entity inquiry.

14. The system of claim 13 wherein the buyer agent is authorized to disclose the portion of buyer entity information in advance of the receiving the seller entity inquiry, the buyer agent automatically disclosing the portion of buyer entity information upon receiving the seller entity inquiry.

15. The system of claim 13 wherein the buyer agent is further configured to communicate with the buyer entity upon receiving the seller entity inquiry to thereby obtain buyer entity authorization to disclose the portion of buyer entity information.

16. The system of claim 13 wherein the seller inquiry includes a request for identification of the buyer entity, the buyer agent being further configured to communicate with the buyer entity upon receiving the seller entity inquiry to thereby obtain buyer entity authorization to disclose the buyer entity identity.

17. The system of claim 13 wherein the first and second data structures are portions of a single data structure.

18. The system of claim 13 wherein the buyer agent query of the active sale list generates a search result, the system further comprising a search storage data structure configured to receive and store the search result.

19. An electronic transaction system for a transaction between a seller entity and a buyer entity comprising:
a first data structure configured to receive and store information; and
a buyer agent program module configured to:
store information related to the buyer entity in the first data structure;
query an active sale list to identify a first seller entity listing that matches buyer-selected search criteria;
generate a buyer entity inquiry requesting additional seller entity data related to the first seller entity listing;
receive the additional seller entity data in response to the buyer entity inquiry if a seller agent for the first seller entity is authorized to respond to the buyer entity inquiry;
receive a seller entity inquiry regarding the buyer entity; and
disclose a portion of buyer entity data from the first data structure in response to the seller entity inquiry if the buyer agent is authorized to respond to the seller entity inquiry.

20. The system of claim 19 wherein the buyer-selected search criteria is selected from a group of search criteria comprising seller geographic location, seller size, or seller industry type.

21. The system of claim 19 wherein the buyer-selected search criteria comprises a key word search term.

22. The system of claim 19 wherein the buyer agent query of the active sale list generates a search result, the system further comprising a search storage data structure configured to receive and store the search result.

23. The system of claim 22 wherein the first data structure and the search storage data structure are portions of a single data structure.

24. The system of claim 19 wherein the buyer agent is configured to repeat the query at predetermined intervals to identify an additional seller entity that matches the buyer-selected search criteria.

25. The system of claim 24 wherein the buyer agent is further configured to provide automatic notification to the buyer entity when the query of the active search list identifies the additional seller entity that matches the buyer-selected search criteria.
